(19) United States
(12) Patent Application Publication
(10) Pub. No.: US 2020/0305440 A1
(43) Pub. Date: Oct. 1, 2020

(54) PLANT TREATMENT COMPOSITION AND METHOD

(71) Applicant: UPL Corporation Limited, Port Louis (MU)

(72) Inventors: Aude Bernardon MÉRY, Plouer sur rance (FR); Fanny BERTRAND, Evesham (GB); Alix BRAMAUD du BOUCHERON-JARDEL, Gorre (FR); Grégory LECOLLINET, Lancieux (FR); Guillaume LEFRANC, Plouer sur rance (FR); Christophe FILLON, Parbayse (FR)

(21) Appl. No.: 16/832,346

(22) Filed: Mar. 27, 2020

Related U.S. Application Data
(60) Provisional application No. 62/824,716, filed on Mar. 27, 2019.

(51) Int. Cl. A01N 65/03; A01N 63/38; A01N 63/22; A01N 65/00; A01N 65/30; A01N 43/16; A01N 59/14; A01N 59/16

(52) U.S. Cl. CPC A01N 65/03; A01N 63/38; A01N 63/22; A01N 59/16; A01N 65/30; A01N 43/16; A01N 59/14; A01N 65/00

(57) ABSTRACT

A plant treatment method and composition are described. A composition includes one or more plant defense enhancers and one or more biostimulants. When applied to plants, the composition can provide enhanced fruit setting and enhanced yield.

### CROSS-REFERENCE TO RELATED APPLICATIONS

This application claims priority to U.S. Provisional Application 62/824,716 filed on Mar. 27, 2019, which is incorporated herein by reference in its entirety.

### TECHNICAL FIELD

The field of art to which this invention generally pertains is plant treatment compositions.

### BACKGROUND

Because of the expense associated with growing various crops, especially for food purposes, there is a constant search for ways to both bring down the costs associated with successfully growing such crops, to reduce damage to crops, and for improving such outcomes as yields.

Accordingly, there is a constant search for methods and compositions to address these challenges.

### BRIEF SUMMARY

A composition including one or more plant defense enhancers and one or more biostimulants is described to produce such outcomes as enhanced fruit setting and enhanced yield.

Additional embodiments include: the composition described above where the plant defense enhancer comprises one or more plant extract, algae filtrate and/or micro-organism; the composition described above where the plant extract comprises horsetail and/or giant knotweed; the composition described above where the algae filtrate comprises Ascophyllum; the composition described above where the micro-organism comprises, Trichoderma, and/or Bacillus subtilis; the composition described above where the biostimulant comprises one or more amino acid, plant extract, algae filtrate, micro-organisms, protein, and/or peptide; the composition described above where the plant extract comprises nettle; the composition described above where the algae filtrate comprises Ascophyllum, and/or Ecklonia maxima; the composition described above where the micro-organism comprises Trichoderma; the composition described above where the plant defense enhancer comprises laminarin; the composition described above where the plant defense enhancer comprises algae, boron and/or molybdenum; and the composition described above provides reduced flower abortion, increased cherelles, and increased harvested pods.

A method of treating plants with the composition described above is also described, resulting in enhanced fruit setting and enhanced yield of the treated plants.

Additional embodiments include: the method described above where the plants comprise fruit, vegetables, or cotton; the method described above where the plants comprise cocoa plants; the method described above providing reduced flower abortion, increased cherelles, and increased harvested pods; and the method described above where the composition is applied to the plants up to 4 times, with at least a two week interval between each application.

These, and additional embodiments, will be apparent from the following descriptions.

### BRIEF DESCRIPTION OF THE DRAWING

FIG. 1 demonstrates examples of the evolution of the number of cherelles for various representative compositions.

FIG. 2 demonstrates examples of the evolution of the number of pods for various representative compositions.

FIG. 3 demonstrates examples of yields for various representative compositions.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

What is disclosed herein is an effective composition for improving the growth of various crops, including, for example, increasing fruit setting and yield. Use of the compositions described herein results in increase in yields of at least 20%. The composition comprises one or more plant defense enhancers and one or more biostimulants such as algae filtrates. Biostimulants which can be used include amino acids, plant extracts, micro-organisms (such as fungi), proteins, and peptides. Plant defense enhancers which can be used include plant extracts, algae filtrates, and micro-organisms (such as yeast, and Bacillus subtilis).

Cherelle wilt is a natural fruit thinning mechanism whereby the young fruit, called cherelles, stop growing. While there are materials, which have been found to increase pod set and reduce cherelle wilt, there is a constant search for materials that can increase fruit setting and yield, especially with the fruit of leguminous plants.

The plant defense enhancers described herein are typically bio-control materials designed to have an effect against pathogenic microorganisms such as fungi, bacteria or oomycetes, which can provoke such things as plant rot and water soaking. For example, the application of these plant defense enhancers can act to promote the formation of phytoalexins, antimicrobial compounds that are produced by the plant in response to a pathogen and which help limit its spread, and, for some particular pathogens, causes dysfunction in specific metabolic processes. Their application can also activate the genes involved in the plant's response to stress and provide the plant with greater resistance to pathogen infection. Since they are also designed to be rapidly absorbed by plants, whether applied by spray or by irrigation, once they have penetrated the plant, they are conveyed throughout the plant tissues.

Representative plant defense enhancers that can be used include VACCIPLANT™ (Arysta). VACCIPLANT is a biocontrol product comprising laminarin at 37 g/L. It typically acts like a vaccine on the crop. The crop thinks it is being attacked by a disease and activates its defense system. Hence the crop is protected against attacks from fungi, bacteria, etc.

The algae filtrates described herein are designed to impact plant physiology and act upon the plants' metabolism. They increase their natural capacities to feed themselves and bear fruit, and combined with the plant defense enhancers described herein, promote healthy growth and increased yields in all fruiting (and other) crops, including cocoa, mango, fruits, tomato, and other vegetables.

Representative algae filtrates that can be used include BM-START® (Arysta), a biostimulant based on Gal42, an algae filtrate and boron 24.8 g/L (grams per liter), molybdenum 0.24 g/L, magnesium (MgO) 43 g/L, and sulfur 88 g/L. It is used to promote fruit setting and fruit calibration on many crops (including fruit trees, and vegetables).

The compositions disclosed herein are particularly effective on fruit trees, vegetable plants, cotton plants, cocoa, etc.

The use of the compositions described herein increase both fruit setting and yield. For example, when used on cocoa plants, the composition promoted flowering and increased yield in the context of abiotic and biotic stress (e.g., phytophthora).

The relative amounts of biostimulant to plant defense enhancer should be in the range of 600 g/L to 800 g/L to 30 g/L to 60 g/L, i.e., in a ratio of about 20:1 to about 13:1.

Representative combinations of biostimulant and plant defense enhancers is further described in the examples below.

### EXAMPLE

FIGS. 1 to 3 demonstrate exemplary comparative testing on cocoa plants. The results demonstrate the enhanced performance of the present composition such as less flower abortion, more cherelles (young cocoa pods), and more harvested pods. The compositions are applied periodically, for example, 2 to 4 times, with an interval between each application, for example, two weeks, three weeks, and up to a two month interval between applications, when the crop is under stress.

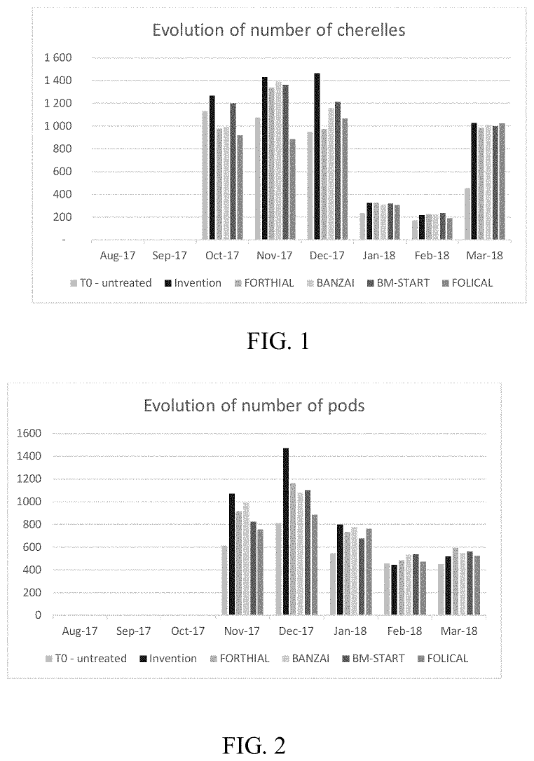

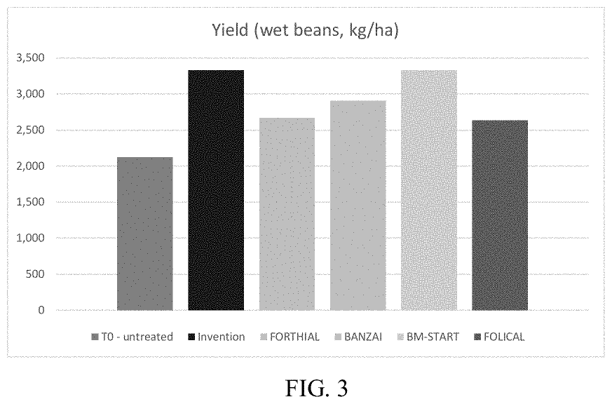

FIGS. 1 and 2 demonstrate examples of the evolution of the number of cherelles and pods over an 8 month period for various representative compositions, and FIG. 3 representative yields for such compositions. The compositions represented include: untreated, a representative composition as disclosed herein, and FORTHIAL, BANZAI, BM-START and FOLICAL compositions. The FORTHIAL composition is an Arysta brand composition comprising magnesium, nitrogen, and laminarin. The BANZAI composition is an Arysta brand composition comprising nitrogen (N) 15% by weight (ureic 10.0% w/w and nitrate derived 5.0%), calcium (Ca) 7% by weight (CaO 9.8% by weight) in combination with Speedo™ material, a Plant Impact brand composition (see UK patent number 2431638, the disclosure of which is hereby incorporated by reference herein) and Alethea™ a Plant Impact brand material (see PCT patent application number PCT/GB2005/001562 the disclosure of which is hereby incorporated by reference herein) in combination with iron (Fe) 2.0% by weight, copper (Cu) 0.5% by weight, zinc (Zn) 2.0% by weight, manganese (Mn) 1.0% by weight, magnesium (Mg) 0.3% by weight and boron (B) 0.025% by weight. The BM-START® composition is an Arysta brand material comprising algae, boron, molybdenum, magnesium, and sulfur. The FOLICAL composition is an Arysta brand composition comprising algae filtrates and calcium. All products are applied 4 times in the trial: the BM-START composition at 2 liters per hectare (2 L/ha); the FORTHIAL composition at 2 L/ha; the FOLICAL composition at 6 L/ha; the BANZAI composition at 1.6 L/ha. On other crops, less can be applied. The results in the figures demonstrate that with the improved composition described herein, more pods can be seen on the trees, hence a productivity increase. Also, it demonstrates that less pods can be discarded due to disease. FIG. 3 demonstrates examples of yields for various representative compositions. The improved composition described herein provides a higher yield compared to conventional compositions currently used as demonstrated by the figures.

As described herein, these problems and others in this area are addressed by the invention described herein. Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition comprising one or more plant defense enhancers and one or more biostimulants.

2. The composition of claim 1, wherein the plant defense enhancer comprises one or more of a plant extract, an algae filtrate, and a micro-organism.

3. The composition of claim 2, wherein the plant extract comprises horsetail, giant knotweed, or a combination thereof.

4. The composition of claim 2, wherein the algae filtrate comprises Ascophyllum.

5. The composition of claim 2, wherein the micro-organism comprises Trichoderma, Bacillus subtilis, or a combination thereof.

6. The composition of claim 1, wherein the biostimulant comprises one or more of an amino acid, a plant extract, an algae filtrate, micro-organisms, a protein, a peptide, or a combination thereof.

7. The composition of claim 6, wherein the plant extract comprises nettle.

8. The composition of claim 6, wherein the algae filtrate comprises Ascophyllum, Ecklonia maxima, or a combination thereof.

9. The composition of claim 6, wherein the micro-organism comprises Trichoderma.

10. The composition of claim 1, wherein the plant defense enhancer comprises laminarin.

11. The composition of claim 1 wherein the plant defense enhancer comprises algae, boron, molybdenum, or a combination thereof.

12. A method of treating plants with the composition of claim 1, wherein treating results in reduced flower abortion, increased cherelles, and increased harvested pods.

13. A method of treating plants with the composition of claim 1, wherein treating results in enhanced fruit setting and enhanced yield of the treated plants.

14. The method of claim 13, wherein the plants comprise fruit, vegetables, or cotton.

15. The method of claim 13, wherein the plants comprise cocoa plants.

16. The method of claim 13, wherein treating results in reduced flower abortion, increased cherelles, and increased harvested pods.

17. The method of claim 13, wherein the composition is applied to the plants up to 4 times, with at least a two week interval between each application.
